(19) United States
(12) Patent Application Publication
(10) Pub. No.: US 2008/0019893 A1
(43) Pub. Date: Jan. 24, 2008

(54) Method For Manufacturing Metal Loading Carbon Material

(75) Inventors: Sumio Iijima, Aichi (JP); Masako Yudasaka, Ibaraki (JP); Katsuyuki Murata, Ibaraki (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC Corporation, Tokyo (JP)

(21) Appl. No.: 11/573,663

(22) PCT Filed: Aug. 12, 2005
(86) PCT No.: PCT/JP05/14835

§ 371 Date: Jun. 12, 2007

(30) Foreign Application Priority Data
Aug. 13, 2004 (JP) 2004-236195

(51) Int. Cl. C01B 31/02; B01J 20/20; B01J 20/30; B01J 35/02

(52) U.S. Cl. 423/182; 423/300; 423/325; 423/339; 423/344; 423/347; 423/400; 423/416

(57) ABSTRACT

It is an object of the present invention to provide a new technical means capable of controlling a loading position for enabling the selection of the function and activity as a catalyst, an adsorption material and a reactive material or the like, and controlling the loading amount. A method for manufacturing a metal loading carbon material, comprises the step of contacting a carbon material, or the carbon material subjected to an oxidation treatment, reduction treatment or oxidization/reduction treatment with a metal component-containing solution so that a metal is carried by controlling a loading position of the metal.

### TECHNICAL FIELD

The invention of the present application relates to a method for manufacturing a metal loading carbon material obtained by loading metal on a carbon material such as a nanostructure useful as a catalyst, an adsorption material and a separating material or the like.

### BACKGROUND ART

A carbon material has been conventionally used as the adsorption material, the separating material and a catalyst carrier or the like, and attentions have been recently focused on the feature as a nanostructure with the appearance of a nanotube and nanohorn.

The examination for the carbon material mainly composed by the nanostructure such as the carbon nanohorn and carbon nanotube has been also energetically advanced. Since a report in which, for example, a single-wall carbon nanohorn and the carbon nanohorn in which fine holes are opened on the wall part and the tip part have been used as the adsorption material and the catalyst carrier for loading the metal, and proposals (Japanese Patent Application Laid-Open (JP-A) No. 2002-159851, No. 2002-326032) have been performed, the following methods have been proposed: a method (Japanese Patent Application Laid-Open (JP-A) No. 2003-25297) for manufacturing the carbon nanohorn on which a metal or the like is carried by evaporating the carbon material and substances such as the metal; a method (Japanese Patent Application Laid-Open (JP-A) No. 2003-181288) for contacting a gaseous noble metal with the carbon material to carry a noble metal; a method for using a solution containing a catalyst metal component to carry a metal on an edge site obtained by cutting the carbon nanotube (Japanese Patent Application Laid-Open (JP-A) No. 2003-261311); a method for reacting a metal with a carbon nano material to carry the metal (Japanese Patent Application Laid-Open (JP-A) No. 2004-59409); and a method (Japanese Patent Application Laid-Open (JP-A) No. 2004-82007) for loading an active species metal on a carbon carrier by a dry diffusion method in a solid phase.

However, though conventionally, the examination and proposal for loading the metal on the carbon material including the nanostructure such as the carbon nanohorn and carbon nanotube have been variously performed, a method for the selectivity and control for the loading position and diameter of the carried particle of the metal largely controlling the function and activity of the metal loading carbon material has not been found out in practice.

It is an object of the invention of the present application to provide a new technical means capable of controlling the loading position for enabling the selection of the function and activity as the catalyst, adsorption material and reactive material or the like, and controlling the diameter of the carried particle so as to solve the conventional problems from the above background.

### DISCLOSURE OF THE INVENTION

A method for manufacturing a metal loading carbon material according to the invention of the present application is characterized by the following items so as to solve the above problems.

<1> A carbon material, or the carbon material subjected to an oxidation treatment, reduction treatment or oxidization/reduction treatment is contacted with a metal component-containing solution so that a metal is carried by controlling a loading position of the metal.

<2> After the carbon material is subjected to an oxidation treatment, reduction treatment or oxidization/reduction treatment, the subjected carbon material is contacted with a metal component-containing solution so that a metal is carried by controlling a loading position of the metal.

<3> The oxidation treatment is performed by oxygen or an oxidizer.

<4> The oxidation treatment is a heat treatment within the range of 100° C. to 600° C. in an air current having an oxygen concentration of 1% or more.

<5> The oxidation treatment uses hydrogen peroxide, an inorganic acid or the mixture thereof.

<6> The reduction treatment is performed by hydrogen or a reductant.

<7> The reduction treatment is a heat treatment within the range of 800° C. to 1500° C. in an air current having a hydrogen concentration of 0.1% or more.

<8> The oxidization/reduction treatment is the reduction treatment following the oxidation treatment, or the oxidation treatment following the reduction treatment.

<9> The metal component-containing solution is an aqueous solution or an alcoholic solution.

<10> The metal component-containing solution is a solution containing a salt or complex salt of the metal, or the mixture thereof.

<11> The metal component-containing solution contains a noble metal component, and the noble metal is carried on the carbon material.

<12> The metal component-containing solution is an aqueous solution or ethanol solution containing at least one of complex salts of Pt, Pd, Rh, Ru, Ir, Au or Ag.

<13> The metal component-containing solution is an aqueous solution or ethanol solution containing any one of platinum amine, bisethanol ammonium platinum and dinitro diamine platinum.

<14> The control of the loading position performed by the contact with the metal component-containing solution is performed by a change in a hydrogen ion concentration of the solution.

<15> The carbon material is a carbon nanohorn or a carbon nanotube.

<16> The loading position of the metal is at least any one of the wall surface, outer tip, inner tip and between particles of the carbon nanohorn or carbon nanotube.

<17> The carbon material is a graphite nano-fiber, graphite, amorphous carbon or an activated charcoal carbon black.

<18> The mean particle diameter of the carried metal is within the range of 0.5 nm to 5 nm.

### EFFECT OF THE INVENTION

The invention of the present application described above can realize the method for manufacturing the metal loading carbon material capable of controlling the loading position for enabling the selection of the function and activity as the catalyst, adsorption material and reactive material or the like, and controlling the diameter of the carried particle.

### BRIEF DESCRIPTION OF THE DRAWINGS

FIG. 1 shows the type of a loading position;

FIG. 2 shows the result in the case of gd;

FIG. 3 shows the result in the case of is;

FIG. 4 shows the result in the case of it;

FIG. 5 shows the result in the case of ot; and

FIG. 6 shows the result in the case of w.

### BEST MODE FOR CARRYING OUT THE INVENTION

The invention of the present application has the above feature, and the embodiments will be described below.

Firstly, a manufacturing method according to the invention of the present application is constituted as the following process (A) or (B).

(A) The carbon material, or the carbon material subjected to the oxidation treatment, reduction treatment or oxidization/reduction treatment is contacted with the metal component-containing solution so that the metal is carried by controlling the loading position of the metal.

(B) After the carbon material is subjected to the oxidation treatment, reduction treatment or oxidization/reduction treatment, the subjected carbon material is contacted with the metal component-containing solution so that the metal is carried by controlling the loading position of the metal.

Here, a proper treatment due to oxygen gas or the oxidizer may be taken into consideration for the oxidation treatment. However, treatments using heating within the range of 100° C. to 600° C. in the air current having the oxygen concentration of 1% or more, hydrogen peroxide, the inorganic acid, or the mixture thereof as a more practical suitable means are illustrated.

Various kinds of means of the treatment due to the hydrogen gas or the reductant may be used for the reduction treatment. However, in more practice, the heat treatment within the range of 800° C. to 1500° C. in the air current having the hydrogen concentration of 0.1% or more is suitably taken into consideration.

The introduction and conversion of a functional group or active group according to the position of the outer surface or inner surface of the carbon material are realized by the oxidation treatment, the reduction treatment, and the oxidization/reduction treatment such as the reduction treatment following the oxidation treatment or the oxidation treatment following the reduction treatment. Though the position selectivity of the functional group and active group is different according to the above means and the condition thereof, or the kind (structure) of the carbon material, the position selectivity is easily confirmed.

Though the carbon material according to the invention of the present application may be various kinds of carbon materials, typical examples thereof include the carbon nanotube and the carbon nanohorn in view of the function, usability and use as the metal loading carbon material. These may be a single-wall or a multi layers and may be constituted as an assembly. These may be manufactured and refined by various kinds of means including known methods.

These may be manufactured or processed by conventionally known means, have fine hole openings and be various kinds of materials cut (fractured).

In the case of the carbon nanohorn or carbon nanotube, the loading position of the metal is at least any one of, for example, the outside thereof, inside thereof, inside and outside wall surfaces, outer tip, inner tip and between particles.

Of course, the carbon material may be the graphite nano-fiber, the graphite, the amorphous carbon or the activated charcoal carbon black or the like, and the metal may be carried between the layers thereof.

The invention of the present application is characterized by using the metal component-containing solution. However, in this case, the metal component-containing solution may be the aqueous solution, the organic solvent solution, or the mixture of the aqueous solution and organic solvent solution. Generally, the organic solvent is preferably a polar solvent. Particularly, a consideration is suitably given to the alcoholic solution.

The metal component-containing solution is preferably a solution containing a salt or complex salt of the metal, or the mixture thereof. Though the metal components may be also various components, it is preferable that the solution contains the noble metal component and the noble metal is carried on the carbon material in view of the function and activity as the metal.

More specifically, the metal component-containing solution is the aqueous solution or ethanol solution containing at least one of the complex salts of, for example, Pt, Pd, Rh, Ru, Ir, Au or Ag. Furthermore, for example, when Pt is carried, the metal component-containing solution is the aqueous solution or ethanol solution containing platinum amine, bisethanol ammonium platinum or dinitro diamine platinum.

It is important to change the hydrogen ion concentration of the solution for the control of the metal loading position and particle diameter of the loading metal. Though the range of pH 1 to 11 is generally selected, the following items can usually be used as an indicator or a standard in the case of a structure such as the nanohorn and nanotube in the method according to the invention of the present application.

(1) It is preferable that the solution pH is set to the relatively acidic side for loading the metal on the outside wall surface, inside wall surface and opening part.

In this case, the control of the particle diameter becomes more remarkable by shifting to the alkali side from the neutrality of pH 7 to 9.

(2) So as to carry the metal between the nanostructures, the selectivity can be strengthened by setting the pH to the alkali side.

In the carbon material which is not subjected to the oxidization or reduction treatment, the shift to the stronger alkali side is effective.

(3) So as to carry the metal on an edge site and terrace site, the pH of the alkali side is effective, and the increase of the particle diameter is also the same.

(4) The shift to the acidity pH side and the oxidation treatment are effective so as to carry the metal on the inner side of the tip of the nanohorn.

On the other hand, so as to carry the metal on the outer side of the tip, the shift to the alkali side is effective, and the oxidation treatment at a higher temperature is also effective. This treatment contributes to the increase of the particle diameter.

In the invention of the present application, the particle diameter of the loading metal controlled as described above can be set to the range of 0.5 nm to 5 nm.

Hereinafter, examples are shown, and the present invention will be described in more detail by way of examples. Of course, the present invention is not limited by the following examples.

### EXAMPLES

A single-wall carbon nanohorn (SWNH) was prepared by laser abrasion using a graphite target in an Ar atmosphere. Pt was carried on five kinds of samples of Ag-grown SWNH, SWNHs respectively oxidized in oxygen of 300° C., 400° C., 580° C., and SWNH reduced in 5% hydrogen/helium balance at 1100° C. after being oxidized at 580° C. in oxygen by using the following four kinds of Pt chemicals.

Pt1: tetravalent platinum amine hydroxy salt

Pt2: bisethanol ammonium platinum

Pt3: P salt (dinitro diamine platinum) nitric acid solution

Pt4: P salt (dinitro diamine platinum) nitric acid solution (having a nitric acid concentration lower than that of Pt3)

Referring to the pH of the solution, the pH of Pt1 was 10; the pH of Pt2 was 8; the pH of Pt3 was 3; and the pH of Pt4 was 5.

SWNH and the platinum chemical were mixed and stirred for 1 hour. The resultant mixture was then filtered under pressure and washed in ethanol. The mixture was then dried at 150° C.

TEM observation investigated the loading position and particle diameter of each Pt.

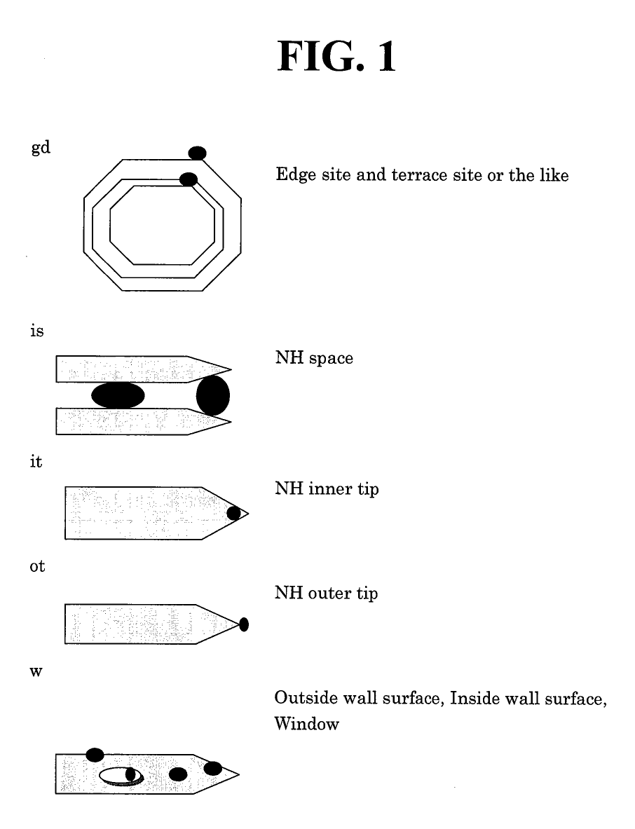

The loading positions were defined as gd, is, it, ot, and w, as shown in FIG. 1.

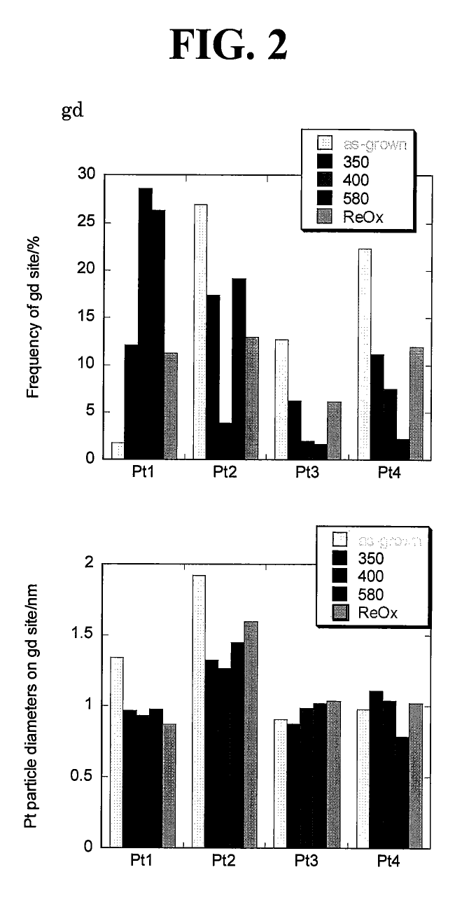

The results were shown in FIG. 2 to FIG. 6. Each figure showed the loading rate (Frequency: %) and platinum particle average grain (Pt particle diameters: nm) of the metal for the above loading positions such as gd and is. These figures confirmed the following.

Referring to gd (FIG. 2), an alkaline chemical had an excellent selectivity. The particle diameter could be controlled by using Pt1 and Pt 2.

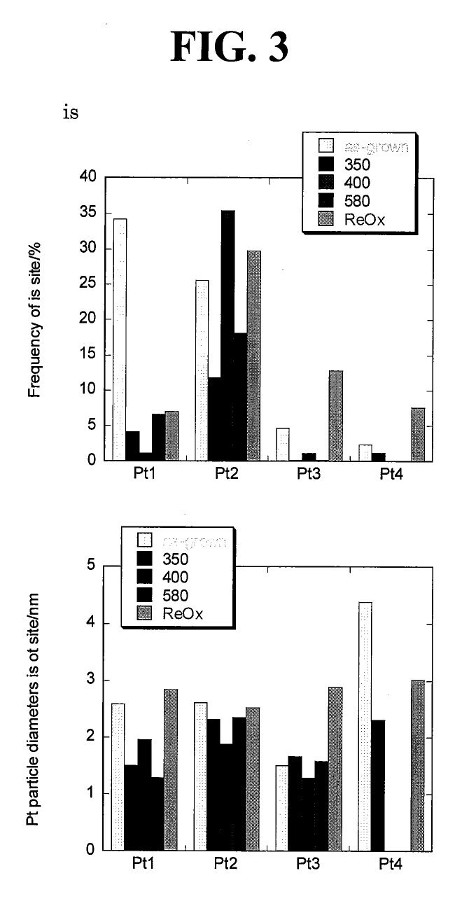

Referring to is (FIG. 3), the metal could be alternatively carried by using a weak alkaline chemical. Referring to as-grown SWNH, a chemical of high pH had an excellent selectivity. The particle diameter could be also controlled as in Pt3 and Pt4.

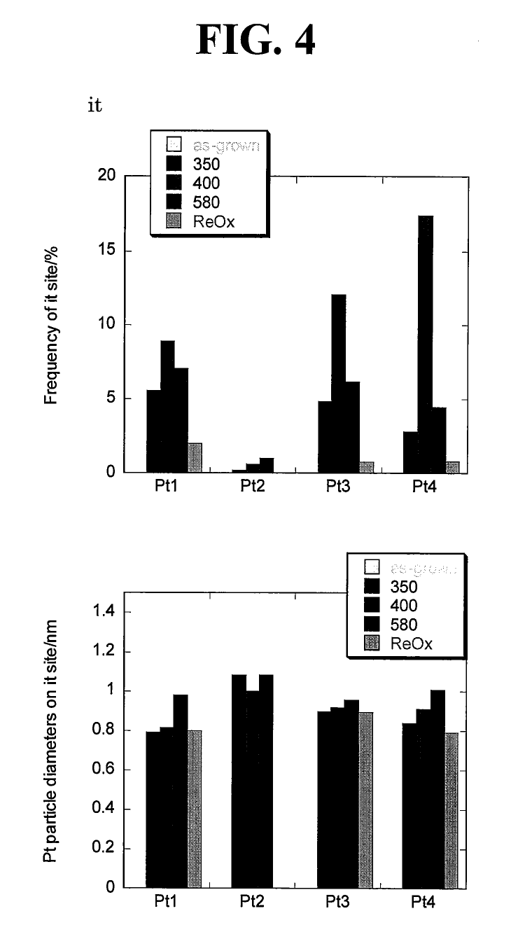

Referring to it (FIG. 4), SWNH processed at 400° C. had an excellent selectivity. A weak alkaline chemical were not mostly selected.

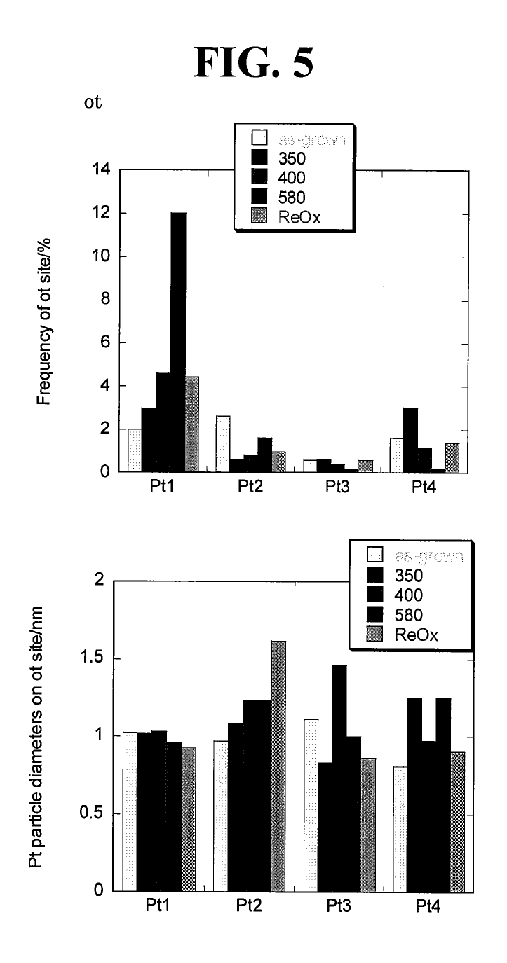

Referring to ot (FIG. 5), an alkaline (pH 10) chemical had an excellent selectivity. The particle diameter could be enlarged by higher an oxidization temperature.

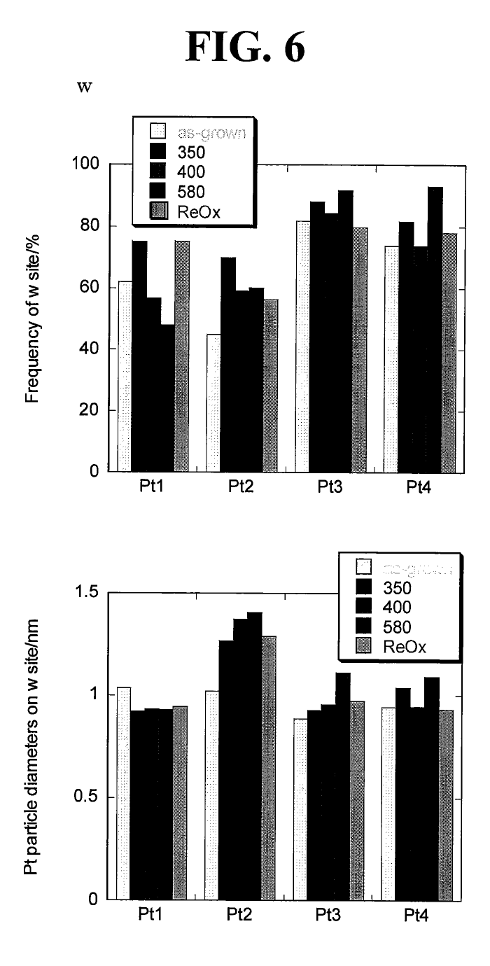

Referring to w (FIG. 6), the chemical of the acidic side had an excellent selectivity. The particle diameter can be controlled by using Pt1 and Pt 2.

1. A method for manufacturing a metal loading carbon material, comprising the step of contacting a carbon material, or the carbon material subjected to an oxidation treatment, reduction treatment or oxidization/reduction treatment with a metal component-containing solution so that a metal is carried by controlling a loading position of the metal.

2. A method for manufacturing a metal loading carbon material, comprising the steps of:
subjecting a carbon material to an oxidation treatment, reduction treatment or oxidization/reduction treatment; and contacting the subjected carbon material with a metal component-containing solution so that a metal is carried by controlling a loading position of the metal.

3. The method for manufacturing the metal loading carbon material according to claim 1, wherein the oxidation treatment is performed by oxygen or an oxidizer.

4. The method for manufacturing the metal loading carbon material according to claim 3, wherein the oxidation treatment is a heat treatment within the range of 100° C. to 600° C. in an air current having an oxygen concentration of 1% or more.

5. The method for manufacturing the metal loading carbon material according to claim 3, wherein the oxidation treatment uses hydrogen peroxide, an inorganic acid or the mixture thereof.

6. The method for manufacturing the metal loading carbon material according to claim 1, wherein the reduction treatment is performed by hydrogen or a reductant.

7. The method for manufacturing the metal loading carbon material according to claim 6, wherein the reduction treatment is a heat treatment within the range of 800° C. to 1500° C. in an air current having a hydrogen concentration of 0.1% or more.

8. The method for manufacturing the metal loading carbon material according to claim 1, wherein the oxidization/reduction treatment is the reduction treatment following the oxidation treatment, or the oxidation treatment following the reduction treatment.

9. The method for manufacturing the metal loading carbon material according to claim 1, wherein the metal component-containing solution is an aqueous solution or an alcoholic solution.

10. The method for manufacturing the metal loading carbon material according to claim 1, wherein the metal component-containing solution is a solution containing a salt or complex salt of the metal, or the mixture thereof.

11. The method for manufacturing the metal loading carbon material according to claim 1, wherein the metal component-containing solution contains a noble metal component, and the noble metal is carried on the carbon material.

12. The method for manufacturing the metal loading carbon material according to claim 11, wherein the metal component-containing solution is an aqueous solution or ethanol solution containing at least one of complex salts of Pt, Pd, Rh, Ru, Ir, Au or Ag.

13. The method for manufacturing the metal loading carbon material according to claim 12, wherein the metal component-containing solution is an aqueous solution or ethanol solution containing any one of platinum amine, bisethanol ammonium platinum and dinitro diamine platinum.

14. The method for manufacturing the metal loading carbon material according to claim 1, wherein the control of the loading position performed by the contact with the metal component-containing solution is performed by a change in a hydrogen ion concentration of the solution.

15. The method for manufacturing the metal loading carbon material according to claim 1, wherein the carbon material is a carbon nanohorn or a carbon nanotube.

16. The method for manufacturing the metal loading carbon material according to claim 15, wherein the loading position of the metal is at least any one of the wall surface, outer tip, inner tip and between particles of the carbon nanohorn or carbon nanotube.

17. The method for manufacturing the metal loading carbon material according to claim 1, wherein the carbon material is a graphite nano-fiber, graphite, amorphous carbon or an activated charcoal carbon black.

18. The method for manufacturing the metal loading carbon material according to claim 1, wherein the mean particle diameter of the carried metal is within the range of 0.5 nm to 5 nm.

19. The method for manufacturing the metal loading carbon material according to claim 2, wherein the oxidation treatment is performed by oxygen or an oxidizer.

20. The method for manufacturing the metal loading carbon material according to claim 2, wherein the reduction treatment is performed by hydrogen or a reductant.

21. The method for manufacturing the metal loading carbon material according to claim 2, wherein the oxidization/reduction treatment is the reduction treatment following the oxidation treatment, or the oxidation treatment following the reduction treatment.

22. The method for manufacturing the metal loading carbon material according to claim 3, wherein the oxidization/reduction treatment is the reduction treatment following the oxidation treatment, or the oxidation treatment following the reduction treatment.

23. The method for manufacturing the metal loading carbon material according to claim 4, wherein the oxidization/reduction treatment is the reduction treatment following the oxidation treatment, or the oxidation treatment following the reduction treatment.

24. The method for manufacturing the metal loading carbon material according to claim 5, wherein the oxidization/reduction treatment is the reduction treatment following the oxidation treatment, or the oxidation treatment following the reduction treatment.

25. The method for manufacturing the metal loading carbon material according to claim 6, wherein the oxidization/reduction treatment is the reduction treatment following the oxidation treatment, or the oxidation treatment following the reduction treatment.

26. The method for manufacturing the metal loading carbon material according to claim 7, wherein the oxidization/reduction treatment is the reduction treatment following the oxidation treatment, or the oxidation treatment following the reduction treatment.

27. The method for manufacturing the metal loading carbon material according to claim 2, wherein the metal component-containing solution is an aqueous solution or an alcoholic solution.

28. The method for manufacturing the metal loading carbon material according to claim 2, wherein the metal component-containing solution is a solution containing a salt or complex salt of the metal, or the mixture thereof.

29. The method for manufacturing the metal loading carbon material according to claim 2, wherein the metal component-containing solution contains a noble metal component, and the noble metal is carried on the carbon material.

30. The method for manufacturing the metal loading carbon material according to claim 2, wherein the control of the loading position performed by the contact with the metal component-containing solution is performed by a change in a hydrogen ion concentration of the solution.

31. The method for manufacturing the metal loading carbon material according to claim 2, wherein the carbon material is a carbon nanohorn or a carbon nanotube.

32. The method for manufacturing the metal loading carbon material according to claim 2, wherein the carbon material is a graphite nano-fiber, graphite, amorphous carbon or an activated charcoal carbon black.

33. The method for manufacturing the metal loading carbon material according to claim 2, wherein the mean particle diameter of the carried metal is within the range of 0.5 nm to 5 nm.
